(19) United States
(12) Patent Application Publication
(10) Pub. No.: US 2021/0004788 A1
(43) Pub. Date: Jan. 7, 2021

(54) TRANSACTION SYSTEM AND TRANSACTION METHOD

(71) Applicants: NURIFLEX INC., Wilmington, DE (US); NURI TELECOM CO., LTD., Seoul (KR)

(72) Inventor: Min Soo KIM, Gyeonggi-do (KR)

(21) Appl. No.: 17/041,224

(22) PCT Filed: Mar. 26, 2018
(86) PCT No.: PCT/KR2018/003518

§ 371 Date: Sep. 24, 2020

(30) Foreign Application Priority Data
Mar. 26, 2018 (KR) 10-2018-0034236

(51) Int. Cl. G06Q 20/36; G06Q 20/40; G06Q 20/06; G06Q 20/32; H04L 9/08

(52) U.S. Cl. CPC G06Q 20/367; G06Q 20/401; G06Q 20/06; H04L 2209/38; H04L 9/0866; H04L 2209/56; G06Q 20/32

(57) ABSTRACT

A transaction system comprises: a terminal device for transmitting, to a server, a remittance request signal for remitting cryptocurrency stored in an electronic wallet; and a transaction server for receiving the remittance request signal from the terminal device, requesting verification of transaction from a blockchain network in order to determine whether the remittance request signal is valid, and remitting the cryptocurrency to an electronic wallet of another terminal device when the remittance request signal is valid as a result of the verification of transaction.

### TECHNICAL FIELD

The present invention relates to a transaction system and a transaction method for cryptocurrency transaction.

### BACKGROUND ART

As the technology advances, cryptocurrency, which is called virtual money, virtual currency, cryptocurrency, or coin using blockchain technology, has emerged. Various definitions are present for the cryptocurrency, but the cryptocurrency is generally defined as digital currency not controlled by a government.

In the related art, an electronic wallet is provided in which an exchange server that mediates transaction of the cryptocurrency can store the cryptocurrency for each individual and when transaction occurs between individuals, the exchange server directly stores a transaction book of the electronic wallet and stores the transaction book in a database. However, if the exchange server was hacked, the stability of the transaction could no longer be guaranteed, and the transparency of the cryptocurrency transaction could not be guaranteed as it was forced to rely on the transaction book stored in the exchange server when transaction cryptocurrency between individuals.

### DISCLOSURE

### Technical Problem

A disclosed embodiment is to provide a transaction system and a transaction method which guarantee stability and transparency of cryptocurrency transaction.

### Technical Solution

According to an aspect, a transaction system includes: a terminal device transmitting, to a server, a remittance request signal for remitting cryptocurrency kept in an electronic wallet; and a transaction server receiving the remittance request signal from the terminal device, requesting transaction verification to a blockchain network in order to determine whether the remittance request signal is available, and remitting the cryptocurrency to an electronic wallet of another terminal device when the remittance request signal is available according to a transaction verification result.

The transaction system may further include another terminal device receiving the cryptocurrency, in which each of the terminal device and the another terminal device may store the electronic wallet and the transaction server may remit the cryptocurrency from the electronic wallet of the terminal device to the electronic wallet of the another terminal device when the remittance request signal is available.

The electronic wallet of the terminal device may store information on a balance of the cryptocurrency held by a user of the terminal device and the electronic wallet of the another terminal device may store information on the balance of the cryptocurrency held by the user of the another terminal device.

The transaction server may store each of the same virtual wallet as the electronic wallet of the terminal device and the same virtual wallet as the electronic wallet of the another terminal device and when the remittance request signal is available, the transaction server may remit the cryptocurrency to the virtual wallet of the another terminal device and synchronize the electronic wallet of the another terminal device to the virtual wallet of the another terminal device.

The electronic wallet of the terminal device may store identification information of the terminal device and balance information of the cryptocurrency kept in the electronic wallet and the electronic wallet of the another terminal device may store the identification information of the terminal device and the balance information of the cryptocurrency kept in the electronic wallet.

The terminal device may include an input unit receiving transaction information of a user, a control unit generating the remittance request signal based on the transaction information of the user, and a communication unit transmitting the remittance request signal to the transaction server.

The terminal device may further include a display unit displaying the balance of the cryptocurrency kept in the electronic wallet of the terminal device.

The transaction server may include a storage unit storing each of the same virtual wallet as the electronic wallet of the terminal device and the same virtual wallet as the electronic wallet of the another terminal device, a communication unit receiving the remittance request signal from the terminal device, and a control unit requesting transaction verification of the terminal device to a blockchain network when the remittance request signal is received through the communication unit, in which the control unit of the transaction server may remit the cryptocurrency from the virtual wallet of the terminal device to the virtual wallet of the another terminal device when the remittance request signal is available according to the transaction verification result.

The communication unit may transmit, to the another terminal device, a synchronization signal for synchronizing the virtual wallet of the another terminal device and the electronic wallet of the another terminal device with each other.

The communication unit may transmit, to the terminal device, another synchronization signal for synchronizing the virtual wallet of the terminal device and the electronic wallet of the terminal device with each other.

According another aspect, a transaction method includes: transmitting, by a terminal device, to a transaction server, a remittance request signal for remitting cryptocurrency kept in an electronic wallet; receiving, by a transaction server, the remittance request signal from the terminal device; requesting, by the transaction server, transaction verification to a blockchain network in order to determine whether the remittance request signal is available; determining, by the transaction server, whether the remittance request signal is available according to a transaction verification result; and remitting, by the transaction server, the cryptocurrency to the electronic wallet of another terminal device when the remittance request signal is available.

The transaction method may further include receiving, by the another terminal device, the cryptocurrency, in which each of the terminal device and the another terminal device may store the electronic wallet, and the remitting of, by the transaction server, the cryptocurrency may include remitting the cryptocurrency from the electronic wallet of the terminal device to the electronic wallet of the another terminal device when the remittance request signal is available.

The electronic wallet of the terminal device may store information on a balance of the cryptocurrency held by a user of the terminal device and the electronic wallet of the another terminal device may store information on the balance of the cryptocurrency held by the user of the another terminal device.

The transaction server may store each of the same virtual wallet as the electronic wallet of the terminal device and the same virtual wallet as the electronic wallet of the another terminal device, and the remitting of, by the transaction server, the cryptocurrency may include remitting, by the transaction server, the cryptocurrency to a virtual wallet of another terminal device when the remittance request signal is available, and synchronizing, by the transaction server, the electronic wallet of the another terminal device with the virtual wallet of the another terminal device.

The electronic wallet of the terminal device may store identification information of the terminal device and balance information of the cryptocurrency kept in the electronic wallet and the electronic wallet of the another terminal device may store the identification information of the terminal device and the balance information of the cryptocurrency kept in the electronic wallet.

The transmitting of, by the terminal device, the remittance request signal to the transaction server may include receiving, by the terminal device, transaction information of the user, generating, by the terminal device, the remittance request signal based on the transaction information of the user, and transmitting, by the terminal device, the remittance request signal to the another terminal device.

The transmitting of, by the terminal device, the remittance request signal to the transaction server may further include displaying, by the terminal device, a balance of the cryptocurrency kept in the electronic wallet of the terminal device.

The transaction server may store each of the same virtual wallet as the electronic wallet of the terminal device and the same virtual wallet as the electronic wallet of the another terminal device, and the remitting of, by the transaction server, the cryptocurrency may include remitting the cryptocurrency from the virtual wallet of the terminal device to the virtual wallet of the another terminal device when the remittance request signal is available according to the transaction verification result.

The transaction method may further include transmitting, by the transaction server, to the another terminal device, a synchronization signal for synchronizing the virtual wallet of the another terminal device and the electronic wallet of the another terminal device with each other.

The transaction method may further include transmitting, by the transaction server, to the terminal device, another synchronization signal for synchronizing the virtual wallet of the terminal device and the electronic wallet of the terminal device with each other.

### Advantageous Effects

According to the solving means, cryptocurrency transaction is performed through a transaction server while a cryptocurrency transaction book of a transaction server is stored in a blockchain network, thereby guaranteeing stability and transparency of the cryptocurrency transaction.

### DESCRIPTION OF DRAWINGS

FIG. 1 is a schematic view of a transaction system according to an embodiment.

FIGS. 2 and 3 are control block diagrams of a terminal device included in a transaction system according to an embodiment.

FIGS. 4 and 5 are control block diagrams of a server included in a transaction system according to an embodiment.

FIG. 6 is a flowchart of a transaction method of a transaction system according to an embodiment.

### BEST MODE

Like reference numerals refer to like elements throughout the specification. This specification does not describe all elements of the embodiments, and general content or content overlapping between the embodiments in the technical field to which the present invention pertains is omitted. The term ‘unit, module, member, block’ used in the specification may be implemented as software or hardware, and according to embodiments, a plurality of ‘units, modules, members, blocks’ may be implemented as one component or it is also possible that one ‘unit, module, member, block’ includes a plurality of components.

Throughout the specification, when a part is said to be “connected” with another part, this includes not only the case of direct connection, but also the case of indirect connection, and the indirect connection includes connection through a wireless communication network.

Further, when any part “includes” any component, unless explicitly described to the contrary, the word “comprise” and variations such as “comprises” or “comprising”, will be understood to imply the inclusion of stated elements but not the exclusion of any other elements.

The terms “first,” “second,”, and the like are used to distinguish one component from other components, but the component is not limited by the terms.

A singular form may include a plural form unless there is a clear exception in the context.

In each step, reference numerals are used for convenience of description, the reference numerals are not used to describe the order of the steps and unless a specific order is clearly stated in the context, each step may occur differently from the order specified above.

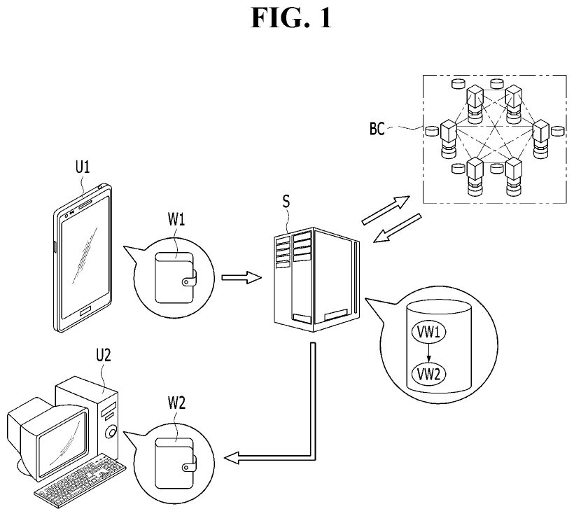

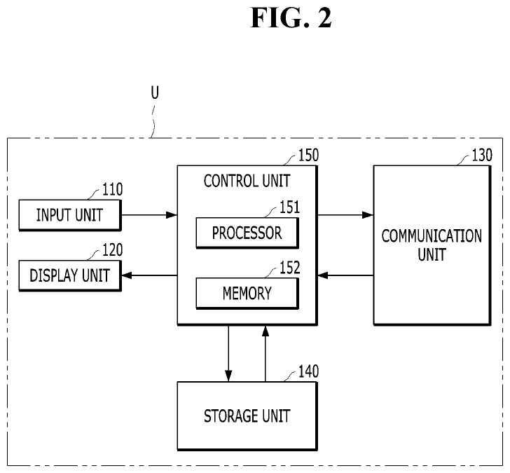

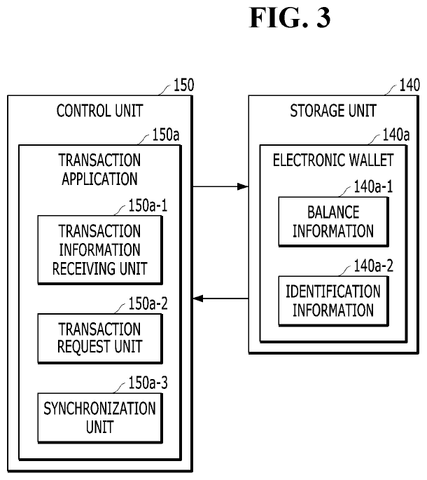

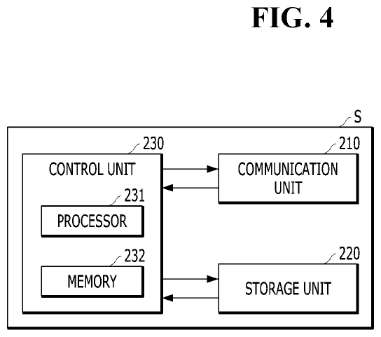

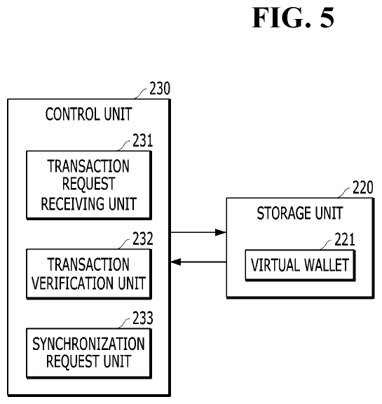

FIG. 1 is a schematic view of a trading system according to an embodiment, FIGS. 2 and 3 are control block diagrams of a terminal device included in a transaction system according to an embodiment, and FIGS. 4 and 5 are control block diagrams of a server included in a transaction system according to an embodiment.

Referring to FIG. 1, a transaction system 1 according to an embodiment includes one or more terminal devices U1 and U2, and a transaction server S.

The terminal devices U1 and U2 may be implemented as a computer or a portable terminal. Here, the computer may include, for example, a notebook, a desktop, a laptop, a tablet PC, a slate PC, and the like, which are equipped with a web browser, and the portable terminal may include, for example, as a wireless communication device in which portability and mobility are guaranteed, all types of handheld based wireless communication devices including Personal Communication System (PCS), Global System for Mobile communications (GSM), Personal Digital Cellular (PDC), Personal Handyphone System (PHS), Personal Digital Assistant (PDA), International Mobile Telecommunication (IMT)-2000, Code Division Multiple Access (CDMA)-2000, W-Code Division Multiple Access (W-CDMA), Wireless Broadband Internet (WiBro) terminal, a smart phone, etc., and wearable devices including watches, rings, bracelets, anklets, necklaces, glasses, contact lenses, or head-mounted-devices (HMD).

The terminal devices U1 and U2 may be implemented as a universal computer or a generally used portable terminal, but are not limited thereto and may be a separate device directly provided from a provider of the transaction server S granting a transaction authority of cryptocurrency.

A user who wishes to trade cryptocurrency may visit a cryptocurrency transaction store where the terminal devices U1 and U2 are installed and trade cryptocurrency, but the present invention is not limited thereto, and the cryptocurrency may be traded by using personal computers or portables with cryptocurrency transaction applications installed.

Electronic wallets W1 and W2 storing information on a balance of the cryptocurrency held by the user may be installed in the terminal devices U1 and U2. The electronic wallets W1 and W2 may be generated by executing cryptocurrency transaction applications of the terminal devices U1 and U2 and the user may keep the cryptocurrency in the electronic wallets W1 and W2 through cryptocurrency mining and purchasing the cryptocurrency through the transaction server S, for example.

Further, identification information of the user may be stored in the electronic wallets W1 and W2 of the terminal devices U1 and U2. Here, the identification information may be, for example, various values for identifying the user, such as an ID and a password of the user.

When the cryptocurrency transaction applications are installed in the terminal devices U1 and U2, if user identification information is input into the cryptocurrency transaction applications, the terminal devices U1 and U2 may display a cryptocurrency balance of the user, which is stored in the electronic wallets W1 and W2 corresponding to the user identification information.

Information on the electronic wallets W1 and W2 of the user may be information which the terminal devices U1 and U2 receive from the transaction server S through the network and may be directly stored in the terminal devices U1 and U2 so as to be also displayed in an offline state in which the terminal devices U1 and U2 are not connected to the network.

The cryptocurrency transaction applications may be provided by the transaction server S or provided from a separate application provider.

The terminal device U1 may trade the cryptocurrency with the other terminal device U2. For convenience of description, the description will be made by taking as an example that the first terminal device U1 transfers the cryptocurrency to the second terminal device U2. In FIG. 1, it is illustrated that the first terminal device U1 is implemented as the portable terminal and the second terminal device U2 is implemented as the desktop, but the embodiment of the terminal devices U1 and U2 is not limited thereto.

The first terminal device U1 may store balance information for the cryptocurrency stored in the electronic wallet W1 of a first user, and the second terminal device U2 may store the balance information for the cryptocurrency stored in the electronic wallet W2 of a second user. Here, the first user and the second user may be the same person or different persons.

When the first user wants to send the cryptocurrency to the second user, the first terminal device U1 may receive the transaction information of the first user, and transmit, to the transaction server S, a remittance request signal to the second terminal device U2 based on the transaction information. Here, the transaction information may include identification information of the first user, the identification information of the second user, and amount information of remitted cryptocurrency.

The transaction server S autonomously stores virtual wallets VW1 and VW2 which are the same as the electronic wallets W1 and W2 of the users to which the electronic wallets W1 and W2 are granted.

When the transaction server S receives, from the first terminal device U1, the remittance request signal to the second terminal device U2, the transaction server S performs transaction between the virtual wallet VW1 of the first terminal device U1 and the virtual wallet VW2 of the second terminal device U2 and requests transaction verification to the blockchain network in order to determine whether the transaction between the virtual wallet of the first terminal device U1 and the virtual wallets VW1 and VW2 of the second terminal device U2 is available, i.e., in order to determine whether the remittance request signal is available.

Here, the blockchain network as a distributed computing system having a public transaction book of the cryptocurrency may be various computers and portable terminals which may be connected to the transaction server S through a wired/wireless network. The description of the blockchain is known, so that a detailed description will be omitted.

The transaction server S may transmit the identification information and the balance information of the first user to the blockchain network based on the remittance request signal received from the first terminal device U1 and determine whether the identification information and the balance information of the first user match the identification information and the balance information of the first user recorded in the public transaction book of the blockchain network, and determine that the transaction is available when both information match each other, as a process of requesting transaction verification to the blockchain network.

When the transaction is available, the transaction server S makes transaction between the virtual wallet VW1 of the first terminal device U1 and the virtual wallet VW2 of the second terminal device U2 and records details for the transaction in the public transaction book and shares the recorded details with the blockchain network. As a result, the cryptocurrency is remitted to the virtual wallet VW2 of the second terminal device U2.

However, when the transaction is not available, it is determined that hacking is attempted to cancel the transaction between the virtual wallet VW1 of the first user and the virtual wallet VW2 of the second user.

In addition, the transaction server S synchronizes the virtual wallet VW2 of the second user and the electronic wallet W2 stored in the second terminal device U2 with each other. Here, synchronization indicates that the balance information of the cryptocurrency kept in the virtual wallet VW2 of the second user and the balance information of the cryptocurrency kept in the electronic wallet of the second user stored in the second terminal device U2 synchronize with each other.

Further, the transaction server S may synchronize the virtual wallet VW1 of the first user and the electronic wallet W1 stored in the first terminal device U1 with each other.

Hereinafter, components of the terminal device U included in the transaction system according to an embodiment will be described with reference to FIGS. 2 and 3. The terminal device U described in FIGS. 2 and 3 may include the first terminal device U1 and the second terminal device U2 described in association with FIG. 1.

Referring to FIG. 2, the terminal device U according to an embodiment may include an input unit 110, a display unit 120, a communication unit 130, a storage unit 140, and a control unit 150.

The input unit 110 may receive the transaction information from the user.

The transaction information may include identification information of a user sending the cryptocurrency, the identification information of a user receiving the cryptocurrency, and the number or amount information of remitted cryptocurrency. The identification information may be, for example, various values for identifying the user, such as an ID and a password of the user.

The input unit 110 may include hardware devices such as various buttons or switches, pedals, keyboards, mouses, track-balls, various levers, handles, or sticks for user input.

Further, the input unit 110 may include a graphical user interface (GUI) such as a touch pad, that is, a software device for the user input. The touch pad is implemented as a touch screen panel (TSP) to form a mutual layer structure with the display unit 120.

When the display unit 120 is constituted by the touch screen panel (TSP) forming the mutual layer structure with the touch pad, the display unit 120 may also be used as the input unit 110.

The display unit 120 may display the cryptocurrency balance of the user, which is stored in the electronic wallet of the user and when the remittance is completed, the display unit 10 may display, to the user, a confirmation message indicating that the remittance is completed. In this case, the input unit 110 may receive an input of remittance cancellation and when the remittance cancellation is input, cryptocurrency transaction between the terminal devices U may be cancelled even when the transaction is available.

The display unit 120 may be provided as a cathode ray tube (CRT), a digital light processing (DLP) panel, a plasma display panel, a liquid crystal display (LCD) panel, an electro luminescence (EL) panel, an electrophoretic display (EPD) panel, an electrochromic display (ECD) panel, a light emitting diode (LED) panel, or an organic light emitting diode (OLED) panel, but is not limited thereto.

The communication unit 130 may transmit the remittance request signal to the transaction server S and receive synchronization information from the transaction server S.

The remittance request signal may include the transaction information input through the input unit 110 and include encrypted transaction information which the control unit 150 generates based on the input transaction information.

Upon receiving the synchronization information from the transaction server S, the control unit 150 may synchronize the electronic wallet of the terminal device U with the virtual wallet of the transaction server S.

The communication unit 130 may include one or more components that enable communication with an external device and may include, for example, at least one of a short-range communication module, a wired communication module, and a wireless communication module.

The short-range communication module may include various short-range communication modules transmitting/receiving the signal by using a wireless communication network in a short range, which include a Bluetooth module, an infrared communication module, a radio frequency identification (RFID) communication module, a wireless local access network (WLAN) communication module, an NFC communication module, a Zigbee communication module, and the like.

The wired communication module may include various cable communication modules including a universal serial bus (USB) module, High Definition Multimedia Interface (HDMI), Digital Visual Interface (DVI), recommended standard232 (RS-232), power line communication, or plain old telephone service (POTS), and the like in addition to various wired communication modules including a controller area network (CAN) communication module, a local area network (LAN) module, a wide area network (WAN) module, or a value added network (VAN) module.

The wireless communication module may include wireless communication modules supporting various wireless communication schemes, which include a global system for mobile communication (GSM), a code division multiple access (CDMA), a wideband code division multiple access (WCDMA), and a universal mobile telecommunications system (UMTS), Time Division Multiple Access (TDMA), Long Term Evolution (LTE), etc., in addition to a Wi-Fi module and a wireless broadband Wibro module.

Referring to FIGS. 2 and 3, the storage unit 140 stores an electronic wallet 140a of the user. As described above, the electronic wallet may be generated by executing a cryptocurrency transaction application 150a of the control unit 150 and store balance information 140a-1 of the cryptocurrency held by the user and identification information 140a-2 of the user.

The storage unit 140 may be implemented as at least one of non-volatile memory devices such as a cache, a Read Only Memory (ROM), a Programmable ROM (PROM), an Erasable Programmable ROM (EPROM), an Electrically Erasable Programmable ROM (EEPROM), and a Flash memory, a volatile memory device such as a Random Access Memory (RAM), or a storage medium such as a hard disk drive (HDD) or a CD-ROM, but is not limited thereto. The storage unit 140 may be implemented as a separate chip from the control unit 160 as illustrated in FIGS. 2 and 3, but is integrated with a memory 152 of the control unit 150 to be implemented as one chip.

The control unit 150 may generate a control signal for controlling each component of the terminal device U.

Specifically, the control unit 150 according to an embodiment may include a transaction information receiving unit 150a-1 executing the cryptocurrency transaction application and receiving the transaction information from the input unit 110.

In addition, the control unit 150 may further include a transaction request unit 150a-2 generating the remittance request signal based on a transaction information input of the user, which is received by the transaction information receiving unit 150a-1 and controlling the communication unit 130 to transmit the generated remittance request signal to the transaction server S.

Further, the control unit 150 may further include a synchronization unit 150a-3 receiving the synchronization information from the communication unit 130 and making the balance information 140a-1 for the cryptocurrency of the user, which is stored in the storage unit 140 match the balance information of the virtual wallet of the user, which is stored in the transaction server S based on the received synchronization information.

Besides, although not illustrated, the control unit 150 may control the display unit 120 to display the cryptocurrency balance of the user, which is kept in the electronic wallet corresponding to the identification information of the user when the user identification information is input into the cryptocurrency transaction application.

To this end, the control unit 150 according to an embodiment may be implemented as a memory 152 storing an algorithm for controlling operations of the components in the terminal device U or data for a program or an application for reproducing the algorithm and a processor 151 performing the aforementioned operations by using the data stored in the memory. In this case, the memory 152 and the processor may be implemented as separate chips, respectively. Alternatively, each of the memory 152 and the processor 151 may be implemented as a single chip.

Hereinafter, components of the transaction server S included in the transaction system according to an embodiment will be described with reference to FIGS. 4 and 5.

Referring to FIG. 4, a transaction server S according to an embodiment includes a communication unit 210, a storage unit 220, and a control unit 230.

The communication unit 210 may receive the remittance request signal from the terminal device U of a cryptocurrency remitter and transmit the synchronization information of the electronic wallet to the terminal device U of the cryptocurrency remitter or the terminal device U of a cryptocurrency receiver.

Further, the communication unit 210 may transmit, to the blockchain network, a verification request signal for determining whether the transaction of the terminal device U is available and receive a transaction verification result from the blockchain network.

Further, when it is determined that the transaction is normal, the communication unit 210 may deliver, to the blockchain network, transaction details between the cryptocurrency remitter and receiver. As a result, new transaction information may be reflected to the blockchain network.

The communication unit 210 may include one or more components that enable communication with an external device and may include, for example, at least one of a short-range communication module, a wired communication module, and a wireless communication module. Since the short-range communication module, the wired communication module, and the wireless communication module are described above, a redundant description is omitted.

Referring to FIGS. 4 and 5, the storage unit 220 stores a virtual wallet 221 of the user, which includes the balance information of the cryptocurrency similarly to the electronic wallet of the user. A book for transaction details between the virtual wallet 221 of the terminal device U and the virtual wallet 221 of the other terminal device U as a public book is shared through the blockchain network. As the book for the transaction details, identification information and cryptocurrency balance information of traders may be shared in the blockchain network.

The storage unit 220 may be implemented as at least one of non-volatile memory devices such as a cache, a Read Only Memory (ROM), a Programmable ROM (PROM), an Erasable Programmable ROM (EPROM), an Electrically Erasable Programmable ROM (EEPROM), and a Flash memory, a volatile memory device such as a Random Access Memory (RAM), or a storage medium such as a hard disk drive (HDD) or a CD-ROM, but is not limited thereto. The storage unit 220 may be implemented as a separate chip from the control unit 230 as illustrated in FIGS. 4 and 5, but may be integrated with a memory 232 of the control unit 230 to be implemented as one chip.

The control unit 230 may generate a control signal for controlling each component of the transaction server S.

Specifically, the control unit 230 according to an embodiment may include a transaction request receiving unit 230a receiving the remittance request signal transmitted from the communication unit 210 by the terminal device U and the transaction request receiving unit 230a may determine transaction information of the cryptocurrency remitter, which is included in the received remittance request signal.

In addition, the control unit 230 may further include a transaction verification unit 230b that generates a verification request signal for requesting transaction verification to the blockchain network in order to determine whether the transaction information included in the remittance request signal is available and delivers the generated verification request signal to the communication unit 210. The transaction verification unit 230b may control the communication unit 210 to transmit the verification request signal to the blockchain network and receive a transaction verification result of the blockchain network from the communication unit 210.

In addition, when it is determined that the transaction is not available according to the transaction verification result (for example, when the identification information or the balance information of at least any one of the cryptocurrency remitter and receiver does not coincide with those of the public transaction book), the transaction verification unit 230b may determine that hacking is attempted and may not permit cryptocurrency remittance between the virtual wallets.

However, when it is determined that the transaction is available according to the transaction verification result (for example, when the identification information or the balance information of both the cryptocurrency remitter and receiver coincides with that in the public transaction book), the transaction verification unit 230b may deliver a signal indicating that the transaction is normal to a synchronization request unit 230c and remit the cryptocurrency from the virtual wallet of the cryptocurrency remitter to the virtual wallet of the cryptocurrency receiver. In addition, when it is determined that the transaction is available according to the transaction verification result, the transaction verification unit 230b may control the communication unit 210 to deliver the transaction details to the blockchain network in order to reflect the transaction between the cryptocurrency remitter and receiver to the book.

When the synchronization request unit 230c receives the signal indicating that the transaction is normal, the synchronization request signal 230c may generate a synchronization signal for synchronizing the electronic wallet of the cryptocurrency receiver, which is included in the transaction information and control the communication unit 210 to deliver the synchronization signal. The synchronization request unit 230c may also generate a synchronization signal for synchronizing the electronic wallet of the cryptocurrency remitter and control the communication unit 210 to deliver the synchronization signal of the cryptocurrency remitter. The terminal device U of the cryptocurrency remitter or the cryptocurrency receiver receiving the synchronization signal synchronizes the virtual wallet thereof, which is stored in the transaction server S with the electronic wallet thereof, which is stored in the terminal device U.

In order to drive each component of the control unit 230, the control unit 230 according to an embodiment may be implemented as a memory 232 storing an algorithm for controlling operations of the components in the transaction server S or data for a program or an application for reproducing the algorithm and a processor 231 performing the aforementioned operations by using the data stored in the memory. In this case, the memory 232 and the processor may be implemented as separate chips, respectively. Alternatively, each of the memory 232 and the processor 231 may be implemented as a single chip.

Meanwhile, at least one component may be added or deleted in respect to performances of the components of the transaction system illustrated in FIGS. 1 to 5. Further, it will be easily appreciated by those skilled in the art that mutual locations of the components may be changed corresponding to the performance or structure of the system.

Meanwhile, some components illustrated in FIGS. 2 to 5 may be hardware components such as software and/or field programmable gate array (FPGA) and (application specific integrated circuit (ASIC).

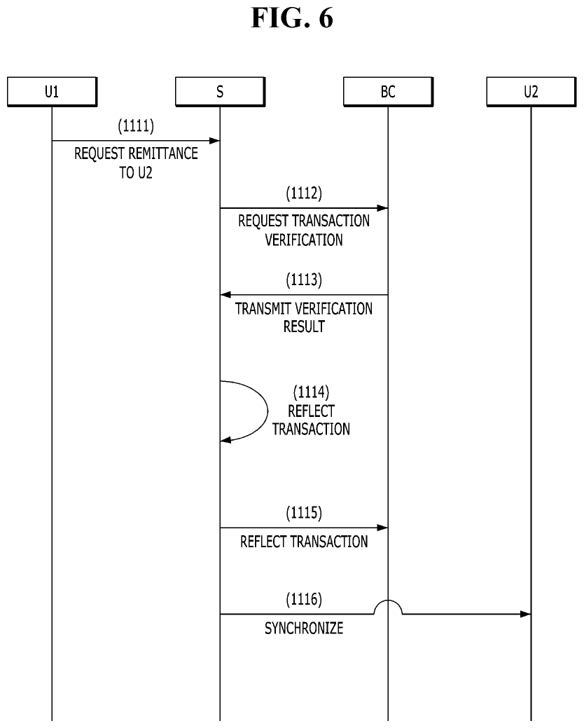

Hereinafter, a transaction method of a transaction system according to an embodiment will be described with reference to FIG. 6. FIG. 6 is a flowchart of a transaction method of a transaction system according to an embodiment.

First, the first terminal device U1 according to an embodiment transmits, to the transaction server S, a remittance request signal for remitting the cryptocurrency to the second terminal device U2 (1111).

The transaction server S that receives the remittance request signal generates a transaction verification request signal for determining whether the transaction between the first terminal device U1 and the second terminal device U2 is available in a blockchain network BC based on the transaction information included in the remittance request signal and transmits the transaction verification request signal to the blockchain network BC (1112).

The blockchain network BC transmits, to the transaction server S, a verification result for determining whether the transaction is available (1113) and the transaction server S that receives the verification result determines whether the transaction between the first terminal device U1 and the second terminal device U2 is a normal transaction.

Determining whether the transaction is the normal transaction may be, for example, comparing identification information and cryptocurrency balance information of a user of the first terminal device U1 written in a public transaction book of the blockchain network BC with the identification information and cryptocurrency balance information of the user of the first terminal device U1, included in the remittance request signal.

Subsequently, when the transaction is the normal transaction, the transaction server S may remit the cryptocurrency from the virtual wallet of the user of the first terminal device U1 to the virtual wallet of the user of the second terminal U2 as much as an amount included in the transaction information (1114). In addition, such a remittance history may be delivered to the blockchain network BC (1115).

In addition, the transaction server S may transmit a synchronization request signal to the second terminal device U2 in order to reflect the balance information of the virtual wallet to the electronic wallet of the second terminal device U2 (1116).

Meanwhile, the disclosed embodiments may be implemented in the form of a recording medium storing instructions executable by a computer. The instructions may be stored in the form of a program code and when the instructions are executed by a processor, the instructions generate a program module to perform operations of the disclosed embodiments. The recording medium may be implemented as a computer readable recording medium.

The computer readable recording medium includes all kinds of recording media storing instructions which may be deciphered by the computer. For example, the recording media may include a read only memory (ROM), a random access memory (RAM), a magnetic tape, a magnetic disk, a flash memory, an optical data storage device, etc.

As described above, the disclosed embodiments are described with reference to the accompanying drawings. Those skilled in the art to which the present invention pertains will understand that the present invention may be implemented in a different form from the disclosed embodiments without changing the technical spirit or essential features of the present invention. The disclosed embodiments are exemplary and should not be construed as being limited.

1. A transaction system comprising:
a terminal device transmitting, to a server, a remittance request signal for remitting cryptocurrency kept in an electronic wallet; and
a transaction server receiving the remittance request signal from the terminal device, requesting transaction verification to a blockchain network in order to determine whether the remittance request signal is available, and remitting the cryptocurrency to an electronic wallet of another terminal device when the remittance request signal is available according to a transaction verification result.

2. The transaction system of claim 1, further comprising:
another terminal device receiving the cryptocurrency,
wherein each of the terminal device and the another terminal device stores the electronic wallet and the transaction server remits the cryptocurrency from the electronic wallet of the terminal device to the electronic wallet of the another terminal device when the remittance request signal is available.

3. The transaction system of claim 2, wherein the electronic wallet of the terminal device stores information on a balance of the cryptocurrency held by a user of the terminal device and the electronic wallet of the another terminal device stores information on the balance of the cryptocurrency held by the user of the another terminal device.

4. The transaction system of claim 2, wherein the transaction server stores each of the same virtual wallet as the electronic wallet of the terminal device and the same virtual wallet as the electronic wallet of the another terminal device and when the remittance request signal is available, the transaction server remits the cryptocurrency to the virtual wallet of the another terminal device and synchronizes the electronic wallet of the another terminal device to the virtual wallet of the another terminal device.

5. The transaction system of claim 2, wherein the electronic wallet of the terminal device stores identification information of the terminal device and balance information of the cryptocurrency kept in the electronic wallet and the electronic wallet of the another terminal device stores the identification information of the terminal device and the balance information of the cryptocurrency kept in the electronic wallet.

6. The transaction system of claim 1, wherein the terminal device includes an input unit receiving transaction information of a user, a control unit generating the remittance request signal based on the transaction information of the user, and a communication unit transmitting the remittance request signal to the transaction server.

7. The transaction system of claim 6, wherein the terminal device further includes a display unit displaying the balance of the cryptocurrency kept in the electronic wallet of the terminal device.

8. The transaction system of claim 1, wherein the transaction server includes
a storage unit storing each of the same virtual wallet as the electronic wallet of the terminal device and the same virtual wallet as the electronic wallet of the another terminal device,
a communication unit receiving the remittance request signal from the terminal device, and
a control unit requesting transaction verification of the terminal device to a blockchain network when the remittance request signal is received through the communication unit,
wherein the control unit of the transaction server remits the cryptocurrency from the virtual wallet of the terminal device to the virtual wallet of the another terminal device when the remittance request signal is available according to the transaction verification result.

9. The transaction system of claim 8, wherein the communication unit transmits, to the another terminal device, a synchronization signal for synchronizing the virtual wallet of the another terminal device and the electronic wallet of the another terminal device with each other.

10. The transaction system of claim 9, wherein the communication unit transmits, to the terminal device, another synchronization signal for synchronizing the virtual wallet of the terminal device and the electronic wallet of the terminal device with each other.

11. A transaction method comprising:
transmitting, by a terminal device, to a transaction server, a remittance request signal for remitting cryptocurrency kept in an electronic wallet;
receiving, by a transaction server, the remittance request signal from the terminal device;
requesting, by the transaction server, transaction verification to a blockchain network in order to determine whether the remittance request signal is available;
determining, by the transaction server, whether the remittance request signal is available according to a transaction verification result; and
remitting, by the transaction server, the cryptocurrency to the electronic wallet of another terminal device when the remittance request signal is available.

12. The transaction method of claim 11, further comprising:
receiving, by the another terminal device, the cryptocurrency,
wherein each of the terminal device and the another terminal device stores the electronic wallet, and
the remitting of, by the transaction server, the cryptocurrency includes remitting the cryptocurrency from the electronic wallet of the terminal device to the electronic wallet of the another terminal device when the remittance request signal is available.

13. The transaction method of claim 12, wherein the electronic wallet of the terminal device stores information on a balance of the cryptocurrency held by a user of the terminal device and the electronic wallet of the another terminal device stores information on the balance of the cryptocurrency held by the user of the another terminal device.

14. The transaction method of claim 12, wherein the transaction server stores each of the same virtual wallet as the electronic wallet of the terminal device and the same virtual wallet as the electronic wallet of the another terminal device, and
the remitting of, by the transaction server, the cryptocurrency includes
remitting, by the transaction server, the cryptocurrency to a virtual wallet of another terminal device when the remittance request signal is available, and
synchronizing, by the transaction server, the electronic wallet of the another terminal device with the virtual wallet of the another terminal device.

15. The transaction method of claim 12, wherein the electronic wallet of the terminal device stores identification information of the terminal device and balance information of the cryptocurrency kept in the electronic wallet and the electronic wallet of the another terminal device stores the identification information of the terminal device and the balance information of the cryptocurrency kept in the electronic wallet.

16. The transaction method of claim 11, wherein the transmitting of, by the terminal device, the remittance request signal to the transaction server includes
receiving, by the terminal device, transaction information of the user,
generating, by the terminal device, the remittance request signal based on the transaction information of the user, and
transmitting, by the terminal device, the remittance request signal to the another terminal device.

17. The transaction method of claim 16, wherein the transmitting of, by the terminal device, the remittance request signal to the transaction server further includes displaying, by the terminal device, a balance of the cryptocurrency kept in the electronic wallet of the terminal device.

18. The transaction method of claim 11, wherein the transaction server stores each of the same virtual wallet as the electronic wallet of the terminal device and the same virtual wallet as the electronic wallet of the another terminal device, and
the remitting of, by the transaction server, the cryptocurrency includes remitting the cryptocurrency from the virtual wallet of the terminal device to the virtual wallet of the another terminal device when the remittance request signal is available according to the transaction verification result.

19. The transaction method of claim 18, further comprising:
transmitting, by the transaction server, to the another terminal device, a synchronization signal for synchronizing the virtual wallet of the another terminal device with the electronic wallet of the another terminal device.

20. The transaction method of claim 19, further comprising:
transmitting, by the transaction server, to the terminal device, another synchronization signal for synchronizing the virtual wallet of the terminal device and the electronic wallet of the terminal device with each other.
